(19) United States
(12) Patent Application Publication
(10) Pub. No.: US 2018/0003892 A1
(43) Pub. Date: Jan. 4, 2018

(54) LIGHT GUIDE ARTICLES AND METHODS OF MAKING

(71) Applicant: 3M INNOVATIVE PROPERTIES COMPANY, St. Paul, MN (US)

(72) Inventor: Andrew J. Ouderkirk, St. Paul, MN (US)

(21) Appl. No.: 15/545,483

(22) PCT Filed: Feb. 15, 2016
(86) PCT No.: PCT/US2016/017932

§ 371 Date: Jul. 21, 2017

Related U.S. Application Data
(60) Provisional application No. 62/121,755, filed on Feb. 27, 2015.

(51) Int. Cl. G02B 6/10; G02B 5/04; G02F 1/1335

(52) U.S. Cl. CPC G02B 6/10; G02B 5/04; G02F 1/133605

(57) ABSTRACT

Foldable and folded light guide articles are described. Foldable light guide articles include a backing, a light guide disposed upon the backing and a prism disposed upon the backing adjacent to the light guide such that when the backing is folded about an axis between the prism and the light guide, a side of the prism is positioned adjacent to and aligned with an end of the light guide. Folded light guide articles include a light guide, a first prism and a second prism. The first prism is disposed adjacent to and aligned with an end of the light guide. The second prism is disposed adjacent to and aligned with the first prism with a low-index material separating the first prism and the second prism.

### BACKGROUND

Backlights used in backlit displays may include a light guide and light sources disposed to inject light into an edge of the light guide. The light output from the light guide may have an intensity distribution that is not uniform over an output surface of the light guide. For example, “hot spots” may appear in regions of the light guide close to the light sources.

### SUMMARY

According to some aspects of the present description, an article having a backing, a first light guide disposed upon the backing and a first prism disposed upon the backing is provided. The first prism is disposed upon the backing adjacent to the first light guide such that when the backing is folded about a first axis between the first prism and the first light guide, a first side of the first prism is positioned adjacent to and aligned with an end of the first light guide.

According to some aspects of the present description, an article having a first light guide, a first prism and a second prism is provided. The first light guide has a first end, a second end opposite the first end, a first major surface, and a second major surface opposite the first major surface. Each of the first and second prisms have a first side, a second side, a third side, and a first edge between the first side and the second side. The third side is longer than the first side and longer than the second side. The first prism is disposed with the first side of the first prism adjacent to and aligned with the first end of the first light guide. The second prism is disposed with the first side of the second prism adjacent to and aligned with the second side of the first prism with a first low-index material separating the second side of the first prism and the first side of the second prism. The first edge of the first prism is disposed adjacent the first edge of the second prism.

According to some aspects of the present description, methods of making articles of the present description are provided.

### BRIEF DESCRIPTION OF THE DRAWINGS

FIG. 1A is a cross-sectional view of a foldable light guide article;

FIG. 1B is a cross-sectional view of a folded light guide article;

FIG. 2A is a cross-sectional view of a foldable light guide article;

FIG. 2B is a cross-sectional view of a folded light guide article;

FIGS. 3-4 schematically illustrate processes for making foldable light guide articles;

FIGS. 5-6 are cross-sectional views of foldable light guide articles;

FIGS. 7A-7D illustrate a process for making a folded light guide article from a foldable light guide article;

FIGS. 8-9 are a schematic cross-sectional views of backlights including folded light guide articles;

FIG. 10 is a schematic cross-sectional view of a backlit display including a folded light guide article;

FIGS. 11A-11C are cross-sectional views of a portion of a folded light guide article;

FIG. 12 shows the illumination uniformity determined by a detector in a simulation;

FIGS. 13A-13B are cross-sectional views of a portion of a folded light guide article;

FIG. 14 shows the illumination uniformity determined by a detector in a simulation; and

FIGS. 15-16 are cross-sectional views of portions of folded light guide articles.

### DETAILED DESCRIPTION

In the following description, reference is made to the accompanying drawings that forms a part hereof and in which are shown by way of illustration. The drawings are not necessarily to scale. It is to be understood that other embodiments are contemplated and may be made without departing from the scope or spirit of the present description.

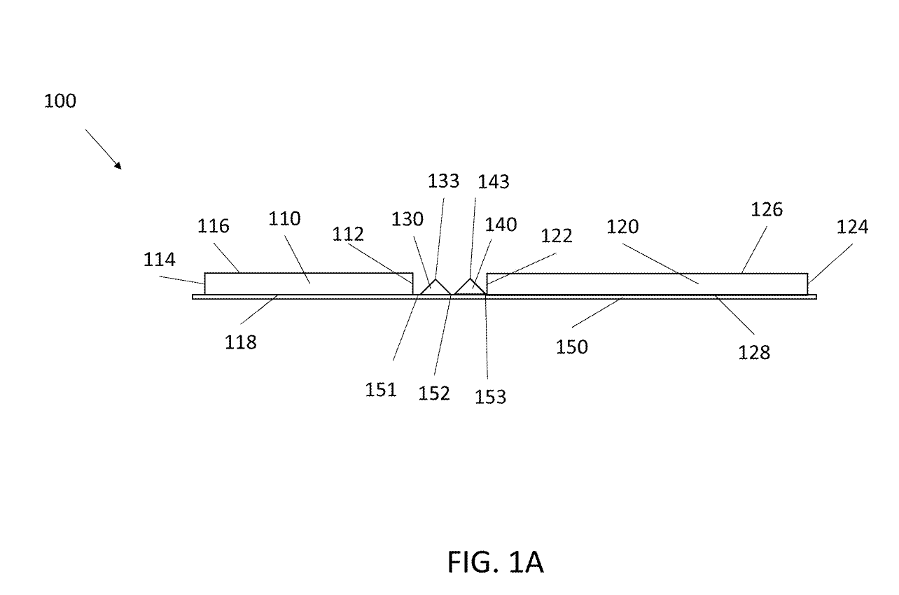

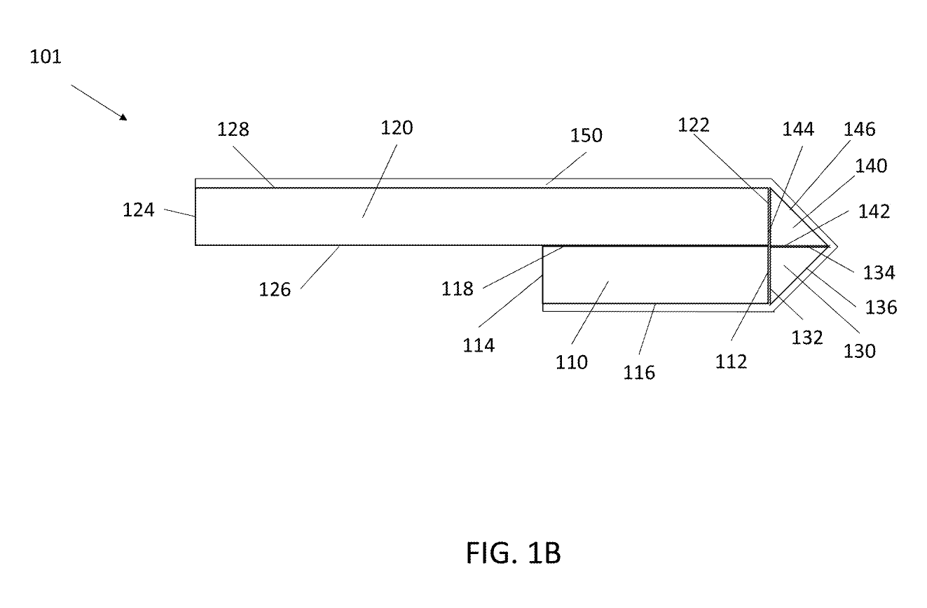

Some backlights used in backlit displays use a light guide with a light source along one or more edges of the light guide. The light source may be, for example, a plurality of light emitting diodes (LEDs) disposed to inject light into an edge of the light guide. The uniformity of the light output from the backlight can be affected by the location and the intensity of the LEDs. It has been found that folded light guide configurations (see, for example, FIG. 1B) where the light source(s) is placed further from the output surface of the light guide can improve the uniformity of the light output while allowing a small bezel width to be maintained in backlights incorporating the folded light guide. It has further been found that strategically placing low-index material(s) between various surfaces of the folded light guide can provide further unexpected uniformity and efficiency improvements. In order for a folded light guide to be effective, it is desirable for the optical elements used in the folded light guide to be precisely positioned and aligned with one another. Methods have been found for achieving precise positioning and alignment and are described herein.

FIG. 1A is a schematic side view of foldable light guide assembly. Foldable light guide article 100 includes first and second light guides 110 and 120, first prism 130 having first edge 133, and second prism 140 having second edge 144, disposed on backing 150. Backing 150 can be folded about first axis 151 between first light guide 110 and first prism 130, about second axis 152 between first prism 130 and second prism 140, and about third axis 153 between second prism 140 and second light guide 120 to form folded light guide article 101 shown in FIG. 1B. In FIG. 1A, the first prism 130 is disposed upon the backing 150 adjacent to the first light guide 110 such that when the backing 150 is folded about a first axis 151 between the first prism 130 and the first light guide 110, a first side 132 of the first prism 130 is positioned adjacent to and aligned with a first end 112 of the first light guide 110 (see FIG. 1B). In FIG. 1A, the second prism 140 is disposed upon the backing 150 adjacent the first prism 130 opposite the first light guide 110 such that when the backing 150 is folded about a second axis 152 between the first prism 130 and the second prism 140, a first side 142 of the second prism 140 is positioned adjacent to and aligned with a second side 134 of the first prism 130 (see FIG. 1B). The second light guide 120 is disposed upon the backing 150 adjacent the second prism 140 opposite the first prism 130 such that when the backing is folded about a third axis 153 between the second prism 140 and the second light guide 120, a second side 144 of the second prism 140 is positioned adjacent to and aligned with a first end 122 of the second light guide 120 (see FIG. 1B).

First light guide 110 has first end 112, second end 114 opposite first end 112, first major surface 116, and second major surface 118 opposite first major surface 116. Second light guide 120 has first end 122, second end 124 opposite first end 122, first major surface 126, and second major surface 128 opposite first major surface 126. When folded to form article 101, the first major surface 126 of the second light guide 120 is disposed adjacent the second major surface 118 of the first light guide 110. First prism 130 has first side 132, second side 134, third side 136, and a first edge 133 between the first side 132 and the second side 134. The third side 136 is longer than the first side 132 and longer than the second side 134. Second prism 140 has first side 142, second side 144, third side 146, and a first edge 143 between the first side 142 and the second side 144. The third side 146 is longer than the first side 142 and longer than the second side 144. In article 101, the first prism 130 is disposed with the first side 132 of the first prism 130 adjacent to and aligned with the first end 112 of the first light guide 110, the second prism 140 is disposed with the first side 142 of the second prism 140 adjacent to and aligned with the second side 134 of the first prism 130. The first edge 133 of the first prism 130 is disposed adjacent the first edge 143 of the second prism 140.

In some embodiments, the first prism 130 has a substantially right triangular cross-section where the third side 136 of the first prism 130 is a hypotenuse of the first prism 130 and is disposed adjacent the backing 150. In some embodiments, the length of the first side 132 of the first prism 130 is substantially equal to the thickness of the first light guide 110. In some embodiments, the length of the first side 132 of the first prism 130 is substantially equal to the length of the second side 134 of the first prism 130 so that first prism 130 is substantially a right isosceles prism (i.e., so that first prism 130 has a substantially right isosceles triangular cross-section). In some embodiments, the second prism 140 has a substantially right triangular cross-section where the third side 146 of the second prism 140 is a hypotenuse of the second prism 140 and is disposed adjacent the backing 150. In some embodiments, the length of the second side 144 of the second prism 140 is substantially equal to the thickness of the second light guide 120. In some embodiments, the length of the first side 142 of the second prism 140 is substantially equal to the length of the second side 134 of the first prism 130. In some embodiments, the length of the first side 142 of the second prism 140 is substantially equal to the length of the second side 144 of the second prism 140 so that second prism 140 is substantially a right isosceles prism (i.e., so that second prism 140 has a substantially right isosceles triangular cross-section).

As used herein, sides of the prisms refer to major surfaces of the prisms, ends of the prisms refer to the minor surfaces of the prisms, and edges of the prism refer to the edges between sides or between a side and an end. Prisms useful with the articles of the present description typically have three major surfaces (sides), two minor surfaces (ends), three edges between adjacent pairs of sides and six edges between a side and an end (three at each end), though other geometries are possible.

Folded light guide article 101 is useful as a light guide panel in backlight of a display. Second end 114 of first light guide 110 can be used as a light injection surface and second major surface 128 of second light guide 120 can be used as an output surface of the light guide panel. Light injected into second end 114 of first light guide 110 reflects from first and second prisms 130 and 140, or from a reflective layer in backing 150 adjacent first and second prisms 130 and 140, into first end 122 of second light guide 120. The light may reflect from the first and second prisms 130 and 140 by total internal reflection (TIR) from third sides 136 and 146. Alternatively, the backing 150, which may be a single layer or may include a plurality of layers, may include a reflective layer in the areas adjacent third sides 136 and 146 which reflect light transmitted through prisms 130 and 140. In some embodiments, the backing includes a low-index layer and light reflects through TIR at an interface with the low-index layer. The backing may also include a reflective layer or a low-index layer in the areas adjacent the first major surface 116 of the first light guide 110 in order to prevent loss of light through first major surface 116. The backing may be transparent in areas adjacent second major surface 128 of second light guide 120. In some embodiments, the backing 150 is removed after forming article 101 and a reflective coating may be applied to one or more of the first major surface 116 and the third sides 136 and 146 of first and second prisms 130 and 140.

Second light guide 120 may include light extraction features which extract light that is injected into first end 122. The extraction features may be formed one first major surface 126 prior to folding article 100 to form article 101, for example, by printing dots or bars onto first major surface 126. After forming extraction features, the first major surface 126 may be coated with a reflective coating.

Suitable reflective coatings that can be used on first major surface 126, first major surface 116, third side 136 and/or third side 146 include metallic coatings or dielectric coatings. Suitable reflective layers that can be attached to a surface or incorporated into portions of the backing include multilayer optical films such as Enhanced Specular Reflector (ESR) film available from 3M Company, St. Paul, Minn.

The first light guide 110 may be attached to first prism 130 with an adhesive, first prism 130 may be attached to second prism 140 with an adhesive, second prism 140 may be attached to second light guide 120 with an adhesive, and the first and second light guides 110 and 120 may be attached together with an adhesive. The adhesives used to attach the various components may be the same or different. Any or all of the adhesives may be low-index optical adhesives.

As used herein, “low-index” material refers to a material having a refractive index less than or equal to about 1.45. As used herein, unless specified differently, “refractive index” refers to refractive index for light having a wavelength of 589 nm (sodium D line) at 25° C. In some embodiments, the low-index material is an optically clear adhesive having a refractive index less than or equal to about 1.45 or less than or equal to about 1.42 or less than or equal to about 1.41 or less than or equal to about 1.39. Suitable low-index optically clear adhesives include Norland Optical Adhesives 1315, 132, 138, 142, and 144 having refractive indices quoted by the manufacturer ranging from 1.315 to 1.44 (available from Norland Products, Cranbury, N.J.). In some embodiments, the low-index material is an ultra low-index (ULI) material having a refractive index less than about 1.3 or less than about 1.2 or even less than about 1.15. Suitable ULI materials include nanovoided materials such as those described in U.S. Pat. Appl. Pub. No. 2012/0038990 (Hao et al.). In some embodiments, the low-index material is a nanovoided low-index adhesive.

In some embodiments, a low-index material, which may be a low-index adhesive or may be air, separates the second side 134 of the first prism 130 and the first side 142 of the second prism 140. In some embodiments, an air gap may separate first and second prisms 130 and 140. An air gap may be provided by fixing first and second prisms 130 and 140 at the ends of the prisms or by bonding first and second prisms 130 and 140 together only near edges of the prisms. Air gaps can also be created by structuring second surface 134 of first prism 130 and/or first surface 142 of second prism 140. The structuring can be provided using a mold or tool used to form the prism(s) or a separate machining step can be used to make the structures.

The first and second light guides 110 and 120 and the first and second prisms 130 and 140 can be made, for example, from any polymeric materials commonly used in optical components. Suitable polymers include acrylates (e.g., poly(methyl methacrylate)(PMMA)) and cyclic olefin copolymers (COPs).

The folded light guide article 101 can improve uniformity of light output through second major surface 128 compared to injecting light directly into an end of a single light guide. Including a low-index material (e.g., air or a low-index adhesive) between the second side 134 of the first prism 130 and the first side 142 of the second prism 140 can further improve uniformity and efficiency of the folded light guide article 101.

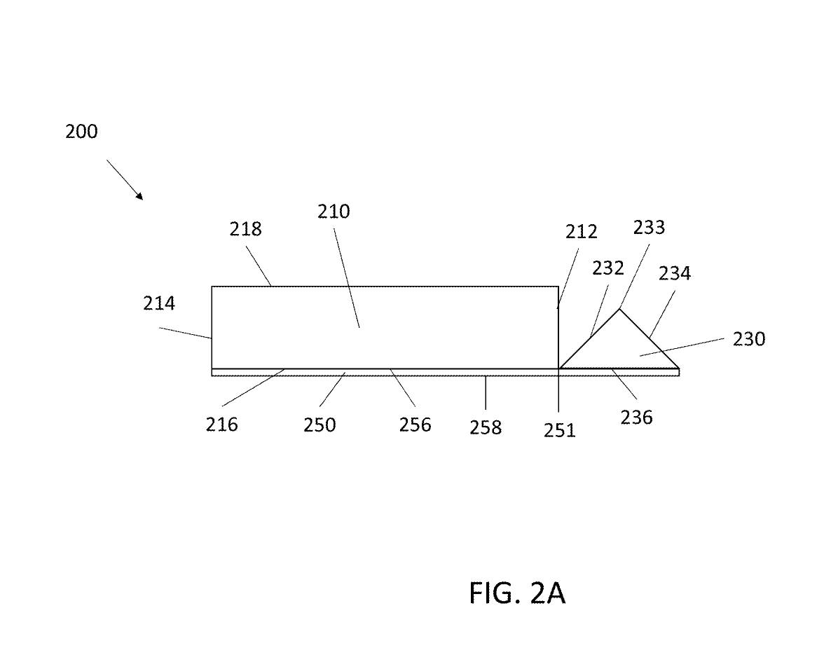

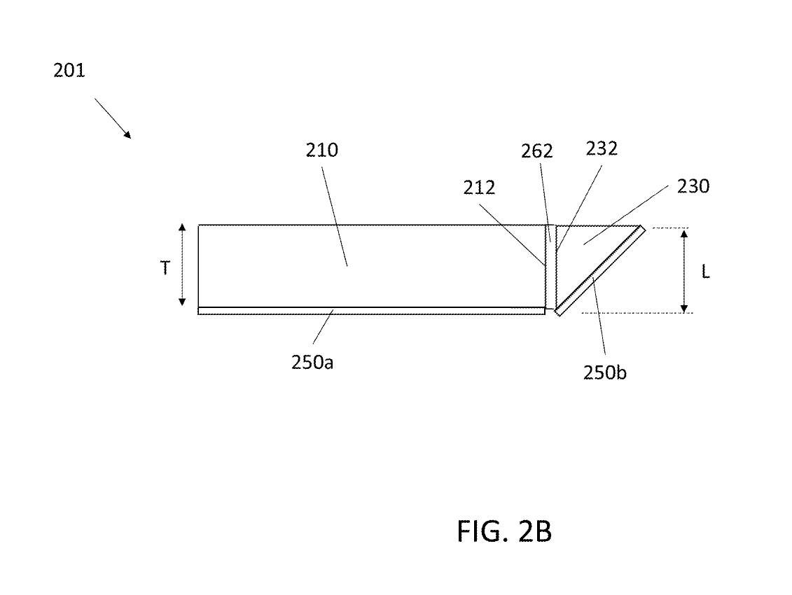

FIG. 2A is a schematic side view of foldable light guide article 200 including light guide 210 and prism 230 disposed on backing 250. Light guide 210 includes opposing first and second ends 212 and 214 and opposing first and second major surfaces 216 and 218. Prism 230 includes first, second and third sides 232, 234 and 236 with third side 236, which is disposed adjacent backing 250, longer than first and second sides 232 and 234. Prism 230 also includes edge 233 between first and second sides 232 and 234. Backing 250 has first major surface 256 and opposing second major surface 258. Light guide 210 and prism 230 are disposed on first major surface 256. Backing 250 can be folded about axis 251 between light guide 210 and prism 230 to form article 201 shown in FIG. 2B. The backing 250 may be flexible so that it bends and stretches when it is folded about axis 251 or it may be fracturable so that the backing 250 breaks apart when it is folded about axis 251. In the embodiment illustrated in FIG. 2B, the backing fractured into two parts 250a and 250b when article 201 is formed from article 200. The length L of first side 232 of prism 230 may be substantially equal to the thickness T of light guide 210 so that the prism 230 is aligned with light guide 210 as illustrated in FIG. 2B.

A low-index material 262 may be disposed between first end 212 and first side 232. In some embodiments, the low-index material may be air or may be a low-index coating. The low-index coating may be a low-index adhesive, a ULI or other low-index material. An air gap can be formed by positioning prism 230 proximate light guide 210 with adhesives along the edges of prism 230 and light guide 210. The spacing between prism 230 and light guide 210 can be controlled by applying a surface structure to first end 212 or first side 232, as described elsewhere. Alternatively, the low index material 262 can be a low index adhesive such as a nanovoided low-index material.

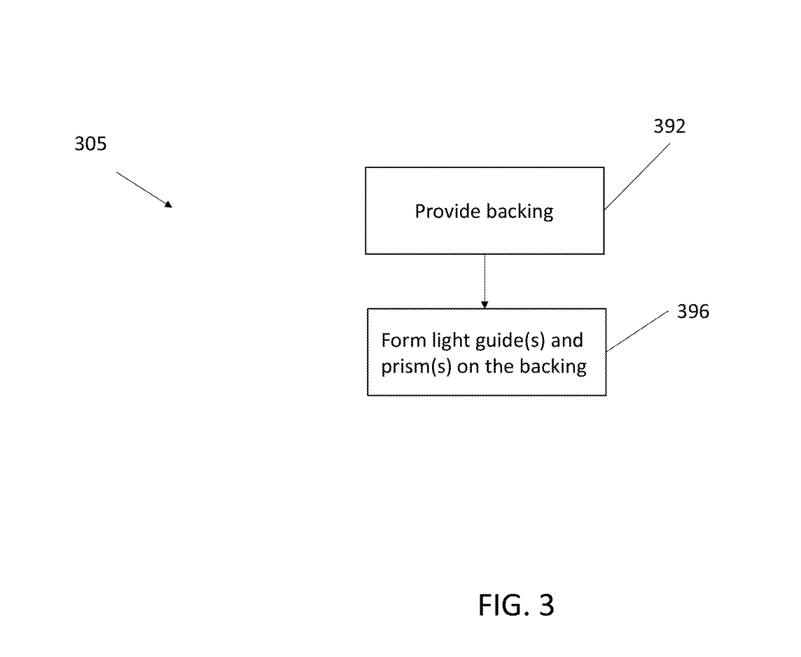

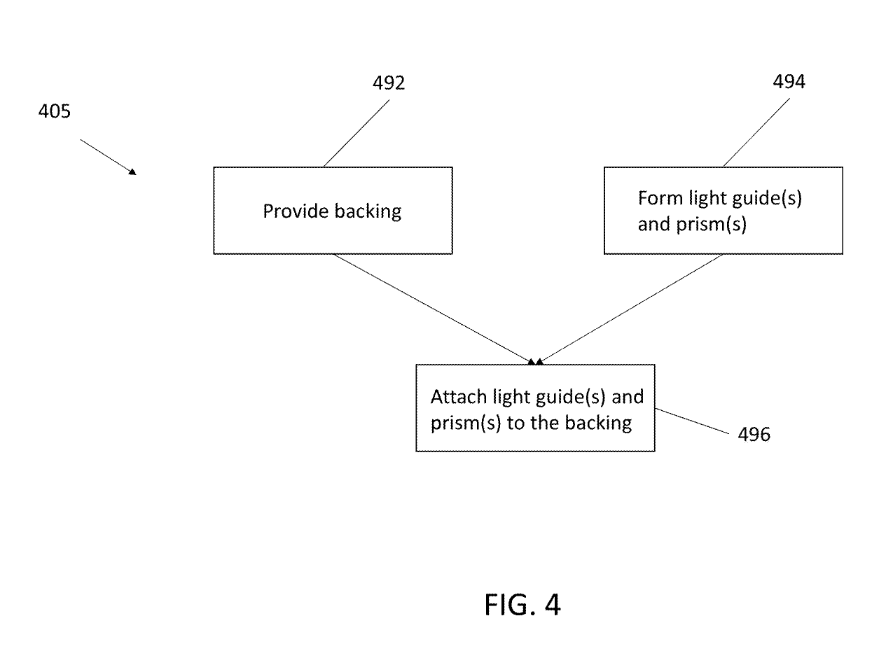

Articles of the present description can be made by molding one or more prisms and one or more light guides onto a backing. In some embodiments, the backing may be made during the molding step. In such embodiments, the prism(s), the light guide(s) and the backing may be made from a common material. In other embodiments, a backing may be a film or a stack of films and the light guide(s) and prism(s) may be formed directly on the backing or may be formed separately and then attached to the backing. Exemplary processes for making articles of the present description are illustrated in FIGS. 3 and 4.

Foldable light guide articles described herein (e.g., foldable light guide articles 100 and 200) can be made by forming light guide(s) and prism(s) on a backing. This is schematically illustrated in process 305 of FIG. 3 where a backing is provided (step 392) and then light guides(s) and prism(s) are formed on the backing (step 396). The light guide(s) and prism(s) may be formed by molding, casting and curing, or machining (e.g., diamond point milling), for example. Prism(s) and light guide(s) can be made by casting and curing a resin composition against a backing using a tool having the desired light guide and prism shapes. The compositions used in such processes may be curable by applying actinic radiation (e.g., ultraviolet (UV) radiation). Cast and cure processes are described in U.S. Pat. No. 5,175,030 (Lu et al.) and U.S. Pat No. 5,183,597 (Lu), for example. Prism(s) and light guide(s) can also be made by molding (e.g., injection molding, insert molding) a material against the backing using a molding tool having the desired light guide(s) and prism(s) shapes. The material used in the molding processes may be a thermoplastic polymer, for example. Alternatively, thermosetting components may be injected into a mold to form the light guide(s) and prism(s).

In some embodiments, the backing may be made during a molding operation along with the light guide(s) and prism(s). In such embodiments, the backing may comprise thin bonded regions between adjacent light guide(s) and prism(s) that may be flexible or fracturable. In such embodiments, the backing and the light guide(s) and prism(s) may comprise a common material.

Foldable light guide articles described herein (e.g., foldable light guide articles 100 and 200) can be made by attaching a block of material to a backing and then machining (e.g., diamond point milling) the block to form light guide(s) and prism(s).

Foldable light guide articles described herein (e.g., foldable light guide articles 100 and 200) can be made by first making light guide(s) and prism(s) and then attaching them to a backing. This is schematically illustrated in process 405 of FIG. 4 where a backing is provided (step 492), light guide(s) and prism(s) are formed (step 494) and then the light guide(s) and prism(s) are attached to the backing (step 496). The light guide(s) and prism(s) can be made by molding (e.g., injection molding) a material using a molding tool having the desired light guide(s) and prism(s) shapes. The light guide(s) and prism(s) can be made by various machining operations including diamond point milling. A pick and place apparatus, for example, can be used to precisely position prism(s) and light guide(s) on the backing. The light guide(s) and prism(s) may be attached to the backing through an adhesive or the backing may include an adhesive layer. The adhesive may be a pressure sensitive adhesive, for example. The adhesive may be a releasable adhesive so that the backing can be removed from the resulting folded light guide (e.g., folded light guide articles 101 and 201) after it has been formed.

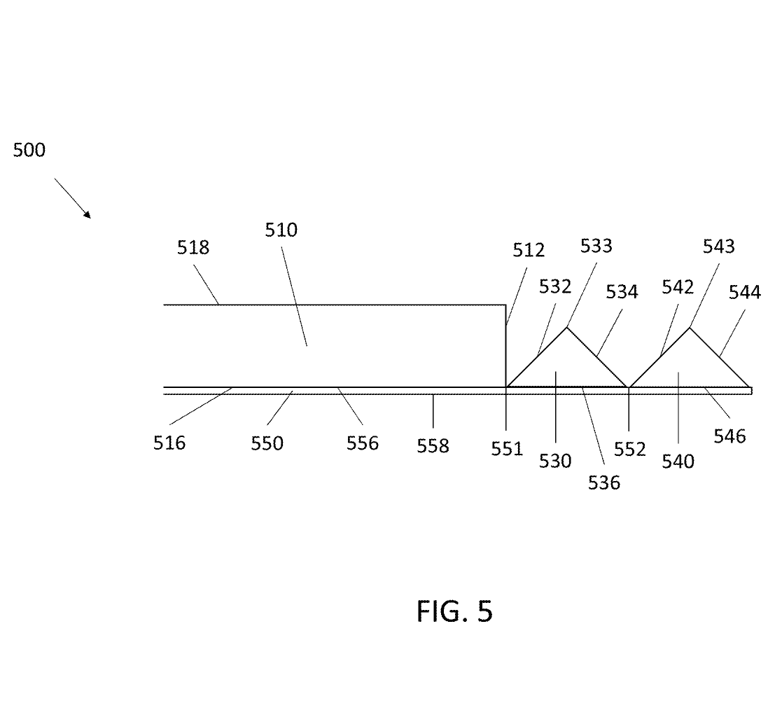

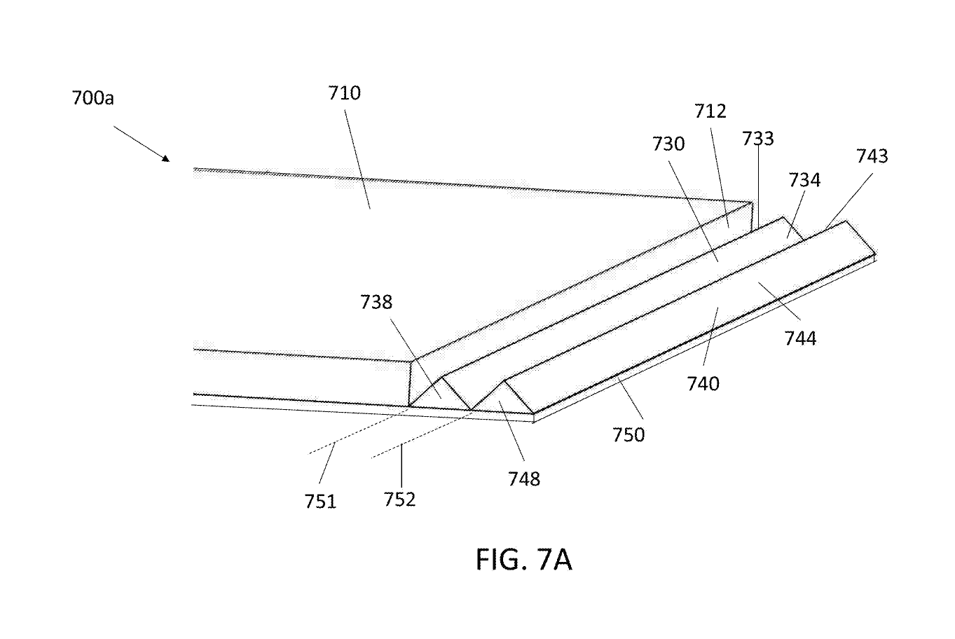

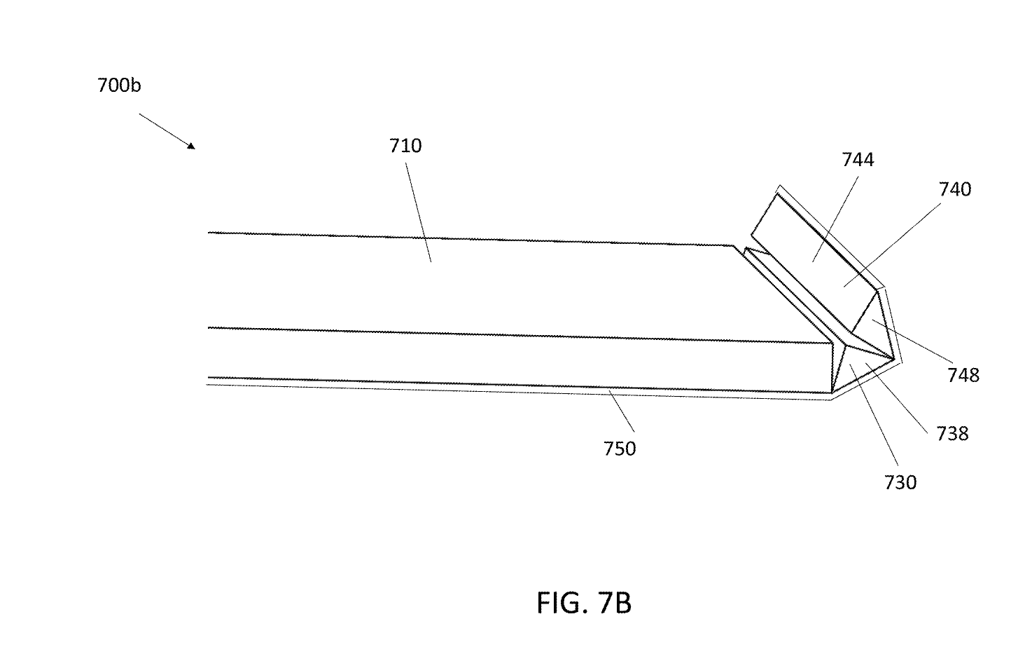

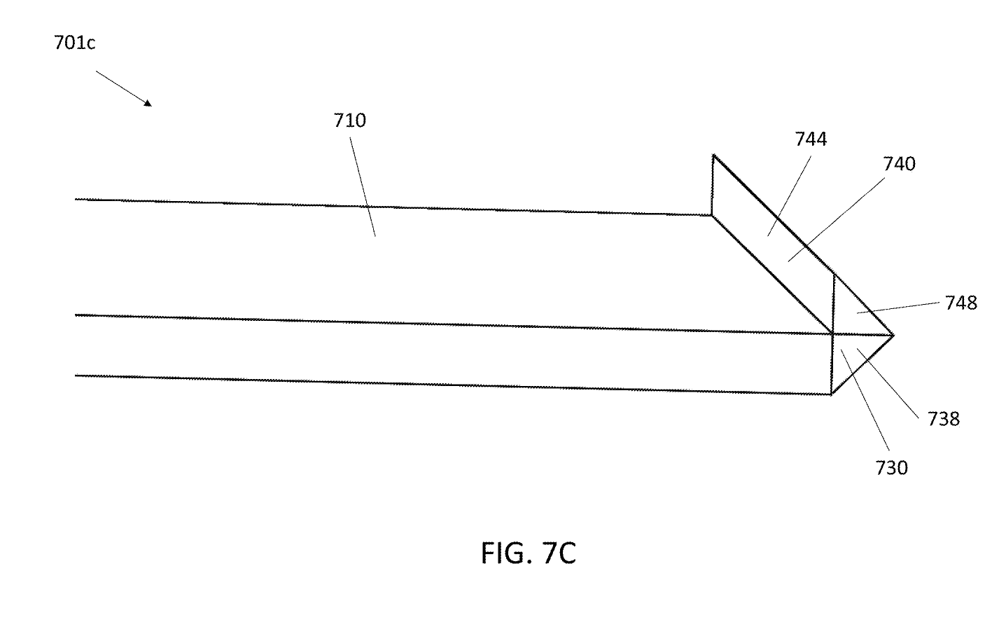

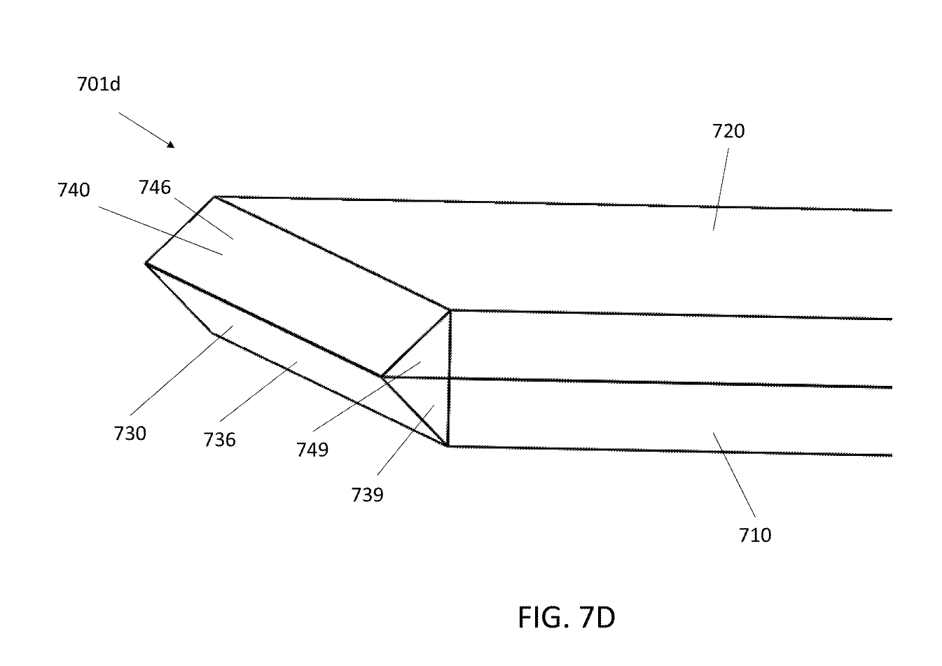

FIG. 5 is a schematic side view of article 500 including light guide 510, first prism 530, and second prism 540 disposed on backing 550. Light guide 510 includes first end 512, an opposing second end (not illustrated), and opposing first and second major surfaces 516 and 518. First prism 530 includes first, second and third sides 532, 534 and 536 with third side 536, which is disposed adjacent backing 550, longer than first and second sides 532 and 534. First prism 530 also includes edge 533 between first and second sides 532 and 534. Second prism 540, which is disposed on backing 550 adjacent to first prism 530 opposite light guide 510, includes first, second and third sides 542, 544 and 546 with third side 546, which is disposed adjacent backing 550, longer than first and second sides 542 and 554. Second prism 540 also includes edge 543 between first and second sides 542 and 544. Backing 550 has first major surface 556 and opposing second major surface 558. Light guide 510, first prism 530 and second prism 540 are disposed on first major surface 556. Backing 550 can be folded about first axis 551 between light guide 510 and first prism 530 and about second axis 552 between first prism 530 and second prism 540 to form an article similar to that shown in FIG. 7C discussed elsewhere.

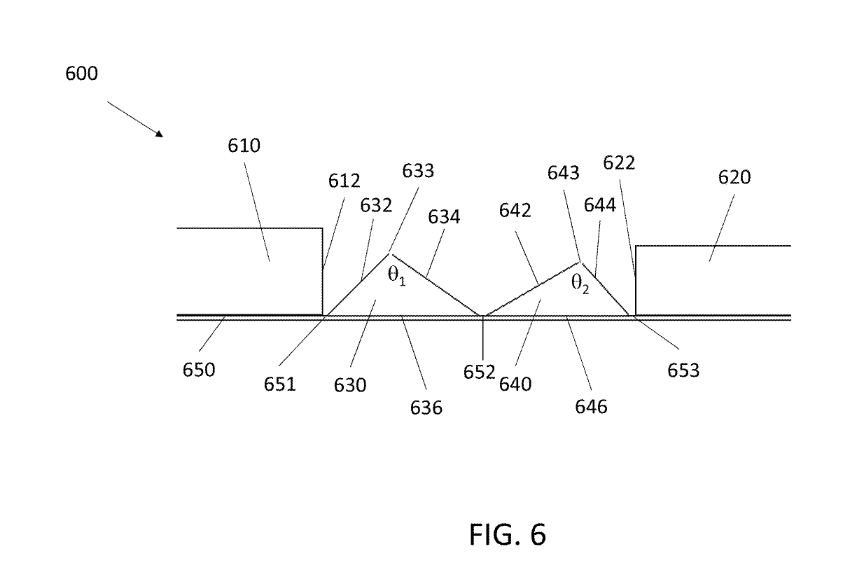

FIG. 6 is a schematic side view of article 600 including first light guide 610, second light guide 620, first prism 630, and second prism 640 disposed on backing 650. First light guide 610 includes first end 612 and an opposing second end (not illustrated). Second light guide 620, which is disposed on backing 650 adjacent second prism 640 opposite first prism 630, includes first end 622 and an opposing second end (not illustrated). First prism 630 includes first, second and third sides 632, 634 and 636 with third side 636, which is disposed adjacent backing 650, longer than first and second sides 632 and 634. First prism 630 also includes edge 633 and angle θ₁ between first and second sides 632 and 634. Second prism 640, which is disposed on backing 650 adjacent to first prism 630 opposite first light guide 610, includes first, second and third sides 642, 644 and 646 with third side 646, which is disposed adjacent backing 650, longer than first and second sides 642 and 654. Second prism 640 also includes edge 643 and angle θ₂ between first and second sides 642 and 644. Backing 650 can be folded about first axis 651 between first light guide 610 and first prism 630, about second axis 652 between first prism 630 and second prism 640, and about third axis 653 between second prism 640 and second light guide 620 to form an article similar to that shown in FIG. 7D discussed elsewhere.

In some embodiments, θ₁ +θ₂ is approximately 180 degrees. This may be desirable so that the first and second light guides 610 and 620 and the first and second prisms 630 and 640 align with ends 612 and 622 substantially flush with each other and with sides 632 and 644 substantially parallel with ends 612 and 622. In some embodiments, θ₁ is approximately 90 degrees and θ₂ is approximately 90 degrees. This may be desirable so that a spacing between sides 634 and 642 is symmetrically placed between first and second light guides 610 and 620 leading to good optical uniformity. In some embodiments, the length of end 612 of first light guide 610 (i.e., the thickness of first light guide 610) is equal to or approximately equal to the length of first side 632 of first prism 630. In some embodiments, the length of second side 634 of first prism 630 is equal to or approximately equal to the length of first side 642 of second prism 640. In some embodiments, the length of end 622 of second light guide 620 (i.e., the thickness of second light guide 620) is equal to or approximately equal to the length of the second side 644 of the second prism 640. In some embodiments, the thicknesses of first and second light guides 610 and 620, the lengths of the first and second sides 632 and 634 of first prism 630, and the lengths of the first and second sides 642 and 644 are all equal or approximately equal.

FIGS. 7A-7D illustrate a process of making a folded light guide article from a foldable light guide article that includes a light guide and two prisms disposed on a backing 750. FIG. 7A is a perspective view of article 700a which includes first light guide 710, first prism 730 and second prism 740 disposed on backing 750. First light guide 710 includes a first end 712 and an opposing second end (not illustrated). First prism 730 includes a first side, a second side 734 and a third side 736 (see FIG. 7D) longer than the first side and the second side 734. First prism 730 also includes a first end 738 and an opposing second end 739 (see FIG. 7D) and includes edge 733 between the first side and the second side 734. Second prism 740 includes a first side, a second side 744 and a third side 746 (See FIG. 7D) longer than the first side and the second side 744. First prism 740 also includes a first end 748 and an opposing second end 749 (see FIG. 7D) and includes edge 743 between the first side and the second side 744. Article 700a can be partially folded about first axis 751 and about second axis 752 to produce intermediate article 700b shown in FIG. 7B. Article 700b can continue to be folded about first and second axes 751 and 752 until the first side of first prism 730 is adjacent the first end 712 of the first light guide 710 and the first side of second prism 740 is adjacent the second side 734 of the first prism 730.

In some embodiments, the backing 750 may be formed along with first light guide 710 and first and second prism 730 and 740. In such embodiments, the backing may be an outer portion of each of the first light guide 710 and the first and second prisms 730 and 740 plus thin bonded regions between the first light guide 710 and the first prism 730 and between the first prism 730 and the second prism 740. The thin bonded regions may be flexible or fracturable. In such embodiments, the backing may be much thinner than that schematically illustrated in FIGS. 7A-7B.

In some embodiments, the first light guide 710 and the first and second prisms 730 and 740 are releasably attached to backing 750 so that the backing can be removed. In other embodiments, the backing is not removed and may include a reflective coating or a low-index layer in areas of the backing adjacent to the first light guide 710, the first prism 730 and/or the second prism 740, as such coatings or layers may be useful to reflect stray light back into the resulting folded light guide. In some embodiments, the backing includes multiple layers. The backing may include a reflective layer or a low-index layer adjacent the first light guide 710, first prism 730 and second prism 740 and may include additional layers which are removable so that removing the additional layers leaves the reflective or low-index layer in place. In some embodiments, the backing provides a reflective coating adjacent one or more of the first light guide 710, first prism 730 and second prism 740. In some embodiments, after the backing is removed, a reflective coating is applied to the third side 736 and/or to the third side 746. If the backing 750 is removed after completely folding article 700b, the result is article 701c shown in FIG. 7C. Alternatively, the backing may be an outer portion of each of the first light guide 710 and the first and second prisms 730 and 740 plus thin bonded regions between the first light guide 710 and the first prism 730 and between the first prism 730 and the second prism 740, in which case, backing 750 may be too thin to be distinctly visible on the length scale of FIG. 7C. In some embodiments, article 701c includes an adhesive layer, which may be a low-index adhesive layer, between first light guide 710 and first prism 730 and/or between first prism 730 and second prism 740.

A second light guide 720 can then be placed adjacent first light guide 710 and second prism 740 to produce folded light guide article 701d shown in FIG. 7D. A reflective or low-index layer (e.g., a low-index adhesive layer) may be disposed on one or both of the adjacent surfaces between first and second light guides 710 and 720. Second light guide 720 may include extraction features arranged to provide a substantially uniform light output so that article 701d may be useful as a folded light guide in a backlight that can be used in a backlit display as described elsewhere.

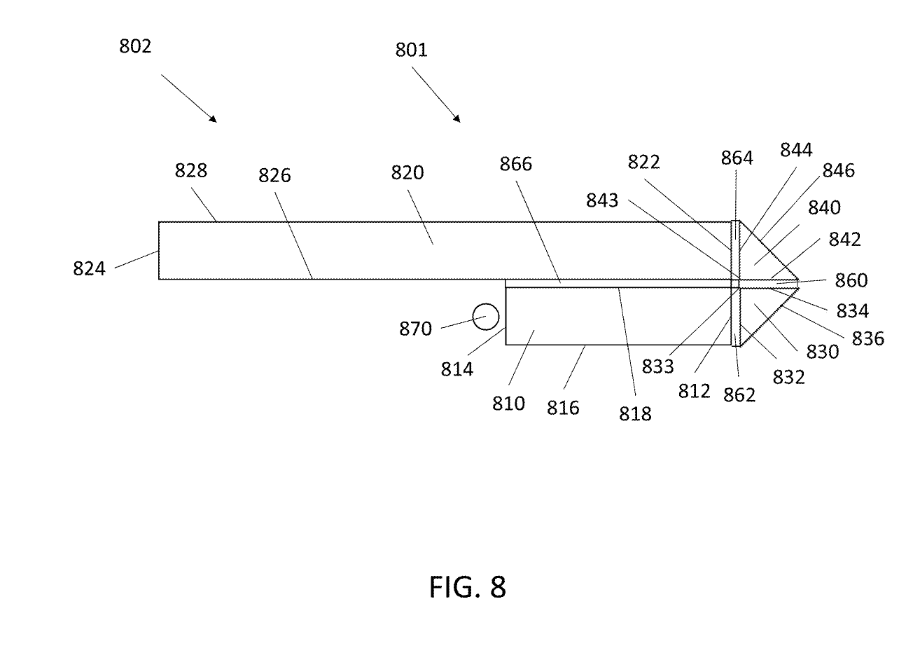

FIG. 8 is a schematic side view of backlight 802 which is suitable for use in a backlit display. Backlight 802 includes folded light guide article 801 and a light source 870. Article 801 includes first and second light guides 810 and 820 and first and second prisms 830 and 840. First light guide 810 has opposing first and second ends 812 and 814 and opposing first and second major surfaces 816 and 818. Second light guide 820 has opposing first and second ends 822 and 824 and opposing first and second major surfaces 826 and 828. First prism 830 has first, second and third sides 832, 834 and 836, with the third side 836 longer than the first and second sides 832 and 834 and with a first edge 833 between first and second sides 832 and 834. Second prism 840 has first, second and third sides 842, 844 and 846, with the third side 846 longer than the first and second sides 842 and 844 and with a first edge 843 between first and second sides 842 and 844. Article 801 includes a first material 860 between the second side 834 of the first prism 830 and the first side 842 of the second prism 840, a second material 862 between first end 812 of the first light guide 810 and the first side 832 of the first prism 830, a third material 864 between the second side 844 of the second prism 840 and the first end 822 of the second light guide 820, and a fourth material 866 between the second major surface 818 of the first light guide 810 and the first major surface 826 of the second light guide 820. The first through fourth materials 860, 862, 864 and 866 may be, for example, low-index adhesives or air, and may include the same or different materials. Air can be included in gaps between the components by using adhesives at the corners of the components, for example. Alternatively, a structured surface or structured surfaces can be used to provide air gaps between the surfaces, as described elsewhere.

In article 801, the first prism 830 is disposed with the first side 832 of the first prism 830 adjacent to and aligned with the first end 812 of the first light guide 810, the second prism 840 is disposed with the first side 842 of the second prism 840 adjacent to and aligned with the second side 834 of the first prism 830 with the first material 860, which may be a low-index material, separating the second side 834 of the first prism 830 and the first side 842 of the second prism 840, and the first edge 833 of the first prism 830 is disposed adjacent to the first edge 843 of the second prism 840. The second side 844 of the second prism 840 is adjacent to and aligned with the first end 822 of the second light guide 820.

Light source 870, which may include one or more LEDs, is disposed adjacent second end 814 of first light guide 810. Light injected from light source 870 through second end 814 is transmitted through first light guide 810, exits first light guide 810 through first end 812, is transmitted through second material 862 into first prism 830 through first side 832, reflects from third side 836, exits first prism 830 through second side 834, is transmitted through first material 860 into second prism 840 through first side 842, reflects from third side 846, exits second prism 840 through second side 844, is transmitted through third material 864 into second light guide 820 through first end 822. Second light guide 820 can include extraction features to direct light out though second major surface 828. First major surface 826 and/or first major surface 816 and/or second major surface 818 may include a reflective layer or a reflective coating.

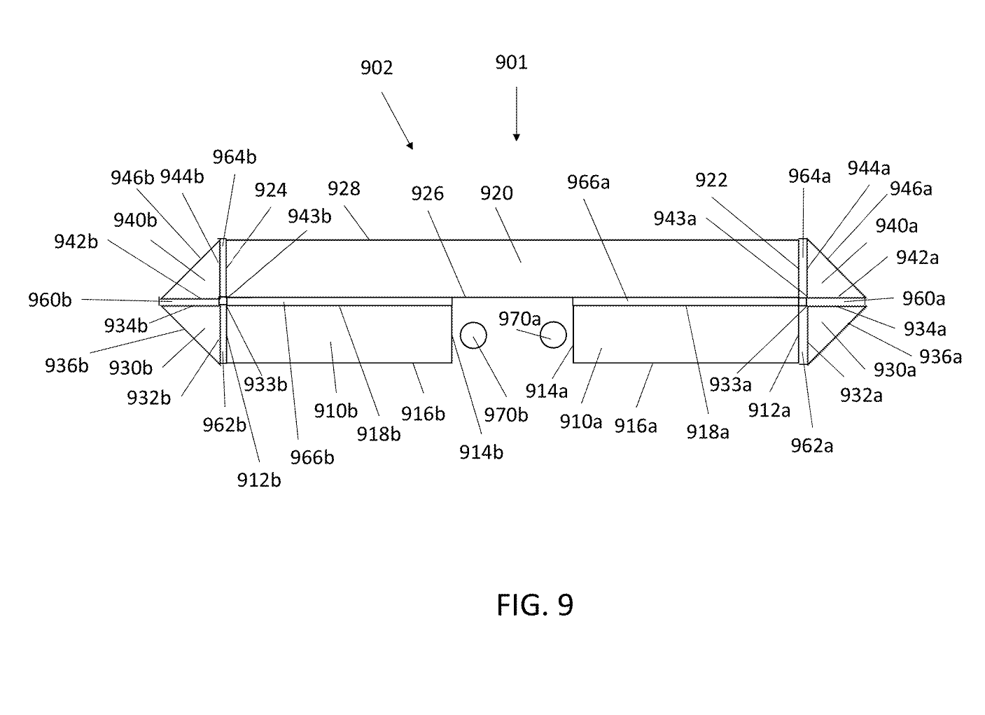

In some embodiments, a folded light guide is provided that is configured to have light injected from opposing ends. This is illustrated in FIG. 9.

FIG. 9 is a schematic side view of backlight 902 which is suitable for use in a backlit display. Backlight 902 includes folded light guide article 901, a first light source 970a and a second light source 970b. Article 901 includes first, second and third light guides 910a, 920 and 910b and first, second, third and fourth prisms 930a, 940a, 930b and 940b. First light guide 910a has opposing first and second ends 912a and 914a and opposing first and second major surfaces 916a and 918a. Second light guide 920 has opposing first and second ends 922 and 924 and opposing first and second major surfaces 926 and 928. Third light guide 910b has opposing first and second ends 912b and 914b and opposing first and second major surfaces 916b and 918b. First prism 930a has first, second and third sides 932a, 934a and 936a, with the third side 936a longer than the first and second sides 932a and 934a and with a first edge 933a between first and second sides 932a and 934a. Second prism 940a has first, second and third sides 942a, 944a and 946a, with the third side 946a longer than the first and second sides 942a and 944a and with a first edge 943a between first and second sides 942a and 944a. Third prism 930b has first, second and third sides 932b, 934b and 936b, with the third side 936b longer than the first and second sides 932b and 934b and with a first edge 933b between first and second sides 932b and 934b. Fourth prism 940b has first, second and third sides 942b, 944b and 946b, with the third side 946b longer than the first and second sides 942b and 944b and with a first edge 943b between first and second sides 942b and 944b.

Folded light guide article 901 can be made from a foldable light guide article that includes first light guide 910a, first prism 930a, second prism 940a, second light guide 920, fourth prism 940b, third prism 930b, and third light guide 910b disposed adjacent each other in the listed order on a flexible or fracturable backing.

The first light guide 910a, which has first and second ends 912a and 914a, is disposed adjacent the first major surface 926 of the second light guide 920 with the first end 912a of the first light guide 910a adjacent to the first end 922 of the second light guide 920. The first prism 930a is disposed adjacent the first end 912a of the first light guide 910a and the second prism 940a is disposed adjacent the first prism 930a and adjacent the first end 922 of the second light guide 920. The third light guide 910b, which has first and second ends 912b and 914b, is disposed adjacent the first major surface 926 of the second light guide 920 with the first end 912b of the third light guide 910b adjacent to the second end 924 of the second light guide 920. The third prism 930b is disposed adjacent the first end 912b of the third light guide 910b and the fourth prism 940b is disposed adjacent the third prism 930b and adjacent the second end 924 of the second light guide 920.

Article 901 includes a first material 960a between the second side 934a of the first prism 930a and the first side 942a of the second prism 940a, a second material 962a between first end 912a of the first light guide 910a and the first side 932a of the first prism 930a, a third material 964a between the second side 944a of the second prism 940a and the first end 922 of the second light guide 920, and a fourth material 966a between the second major surface 918a of the first light guide 910a and the first major surface 926 of the second light guide 920. Article 901 also includes a fifth material 960b between the second side 934b of the third prism 930b and the first side 942b of the fourth prism 940b, a sixth material 962b between first end 912b of the third light guide 910b and the first side 932b of the third prism 930b, a seventh material 964b between the second side 944b of the fourth prism 940b and the second end 924 of the second light guide 920, and an eighth material 966b between the second major surface 918b of the third light guide 910b and the first major surface 926 of the second light guide 920. The first through eighth materials 960a, 962a, 964a, 966a, 960b, 962b, 964b and 966b may be low index materials such as low-index adhesives or air, and may include the same or different materials. Air can be included in gaps between the components by using adhesives at the corners of the components, for example. Alternatively, a structured surface or structured surfaces can be used to provide air gaps between the surfaces.

In article 901, the first prism 930a is disposed with the first side 932a of the first prism 930a adjacent to and aligned with the first end 912a of the first light guide 910a, the second prism 940a is disposed with the first side 942a of the second prism 940a adjacent to and aligned with the second side 934a of the first prism 930a with the first material 960a, which may be a low-index material, separating the second side 934a of the first prism 930a and the first side 942a of the second prism 940a, and the first edge 933a of the first prism 930a is disposed adjacent to the first edge 943a of the second prism 940a. The third prism 930b is disposed with the first side 932b of the third prism 930b adjacent to and aligned with the first end 912b of the third light guide 910b, the fourth prism 940b is disposed with the first side 942b of the fourth prism 940b adjacent to and aligned with the second side 934b of the third prism 930b with the fifth material 960b, which may be a low-index material, separating the second side 934b of the third prism 930b and the first side 942b of the fourth prism 940b, and the first edge 933b of the third prism 930b is disposed adjacent to the first edge 943b of the fourth prism 940b. The second side 944a of the second prism 940a is adjacent to and aligned with the first end 922 of the second light guide 920 and the second side 944b of the fourth prism 940b is adjacent to and aligned with the second end 924 of the second light guide 920.

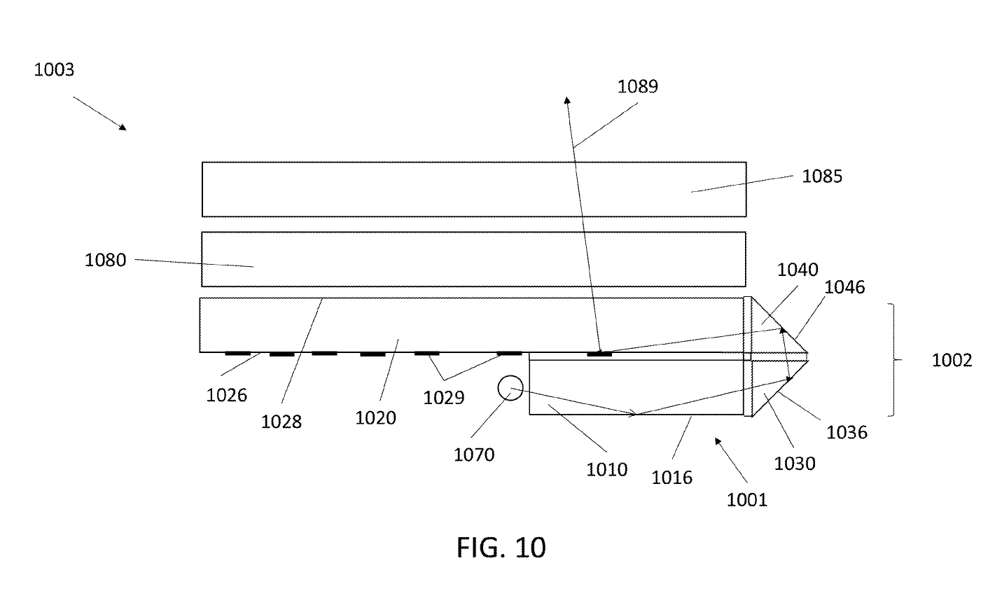

FIG. 10 illustrates the use of the folded light guide articles of the present description in a display. Display 1003 includes backlight 1002, optional optical films 1080, and display panel 1085. Backlight 1002 includes folded light guide article 1001 and light source 1070. Article 1001 includes first and second light guides 1010 and 1020, first and second prisms 1030 and 1040. Backlight 1002 may correspond to backlight 802 and folded light guide article 1001 may correspond to article 801, for example. First light guide 1010 includes first major surface 1016 and an opposing second major surface. Second light guide 1020 includes opposing first and second major surfaces 1026 and 1028 and light extraction features 1029 on first major surface 1026. Light ray 1089 in injected from light source 1070 through first light guide 1010, where it reflects once from first major surface 1016, into first prism 1030 where it reflects from longest side 1036 of the first prism 1030 into second prism 1040 where it reflects from longest side 1046 of the second prism 1040 into second light guide 1020. Light ray 1089 then reflects from one of the light extraction features 1029 and exits the second light guide through second major surface 1028. Light ray 1089 then passes through optional optical films 1080 and display panel 1085. Optional optical films 1080 may include a reflective polarizer and/or prism films, for example.

Light extraction features can be made, for example, by printing dots or bars or otherwise forming extraction features onto first major surface 1026. Folded light guide article 1001 can be made by folding a foldable article similar to article 100 of FIG. 1A, for example. The light extraction features can be printed or otherwise formed on first major surface 1026 prior to folding the foldable article. Alternatively, or in addition, light extractions features can be included at or on second major surface 1028. This can be achieved by printing or otherwise forming light extraction features on a backing of a foldable article prior to attaching the second light guide 1020 to the backing. The backing may be removed after the foldable article is folded into a folded light guide configuration or the backing may be left in place.

### EXAMPLES

A folded light guide article similar to that shown in FIG. 8 that included first and second light guides and first and second prisms was simulated using LightTools Version 8.2.0, available from Synopsis, Mountain View, Calif., USA. The first light guide was simulated as a sheet of polymethylmethacrylate (PMMA) that was 0.5 mm thick by 80 mm wide by 20 mm long. An LED was coupled light to the center of the end of the first light guide opposite the prisms. The other end was coupled to first and second right-angle prisms with mirrored hypotenuses, and the second prism was positioned to direct light into a second light guide (also modeled as PMMA) that was 0.5 mm high by 80 mm wide by 40 mm long. A detector plane was placed 0.25 mm from the first and second prism immersed in the center of both the first and second light guides. Gaps 0.01 mm wide were formed between the light guides and the prisms, and between the two prisms, and the gaps were filled with a material having a refractive index of 1.41.

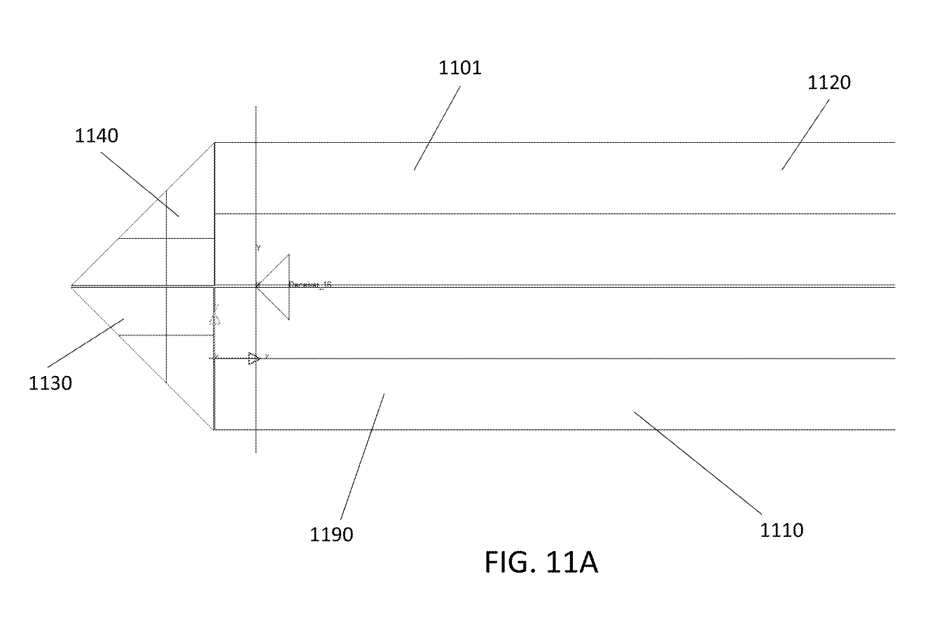

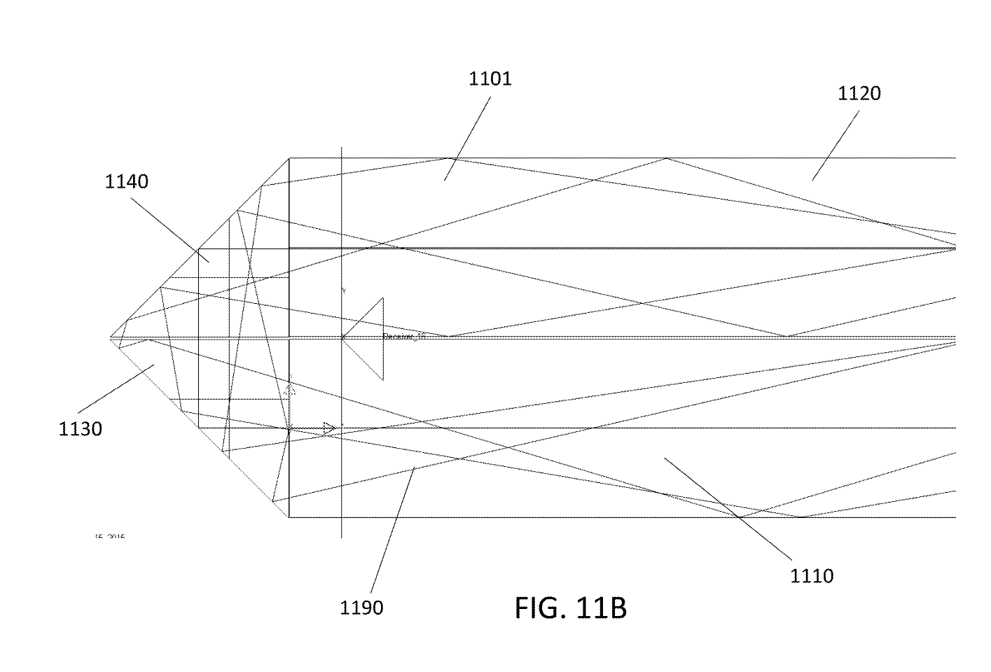

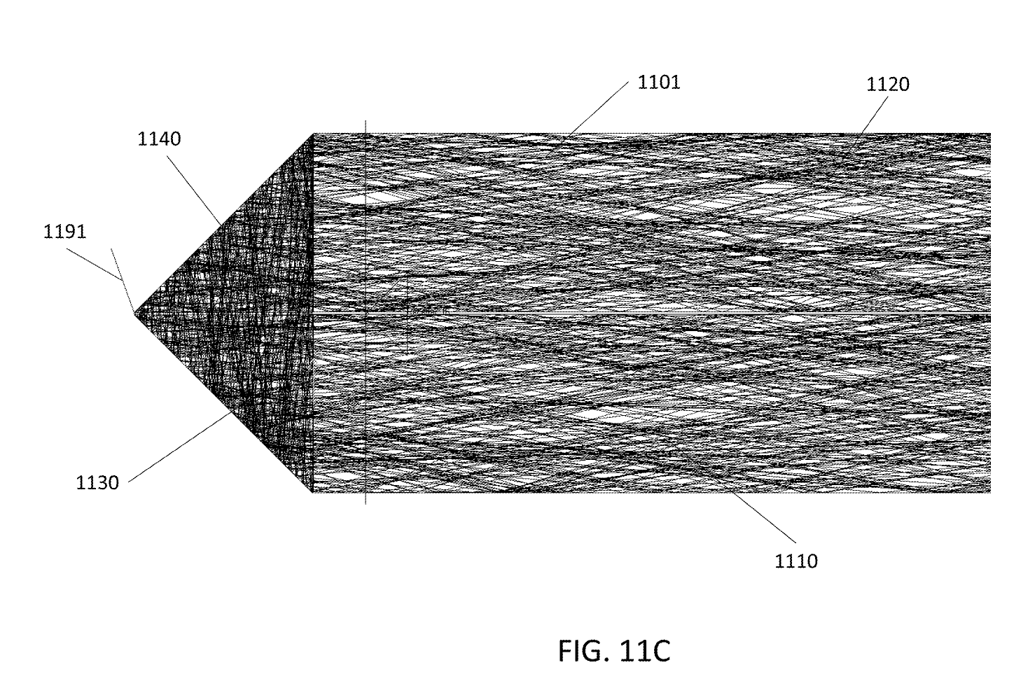

FIGS. 11A-11C show a portion of the simulated folded light guide article 1101 near the first and second prisms 1130 and 1140. Light rays were injected into first light guide 1110. The light rays then reflected from the first and second prisms 1130 and 1140 into second light guide 1120. FIG. 11A shows the folded light guide article 1101 without light rays. FIG. 11B shows the paths of 4 light rays 1190 emitted from the LED. FIG. 11C show the paths of 200 light rays emitted from the LED. In the case of FIG. 11B, no light rays escaped the folded light guide article 1101 and in the case of FIG. 11C only a single light ray 1191 escaped the folded light guide article 1101.

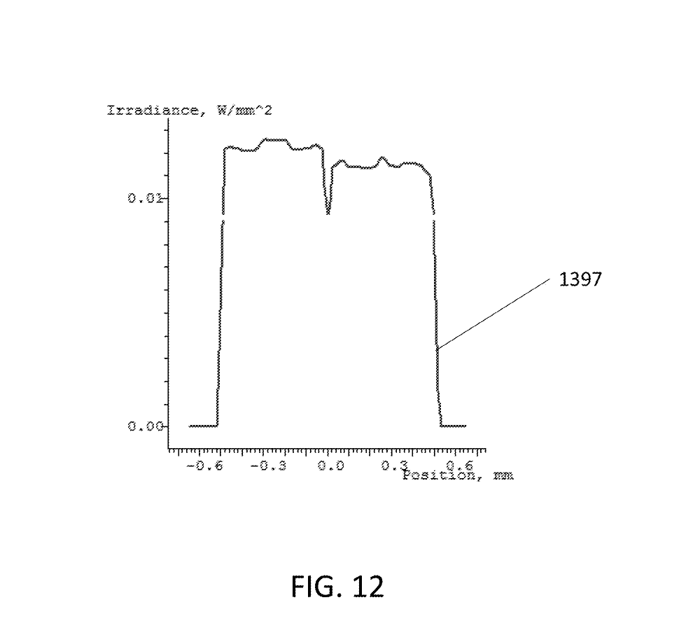

FIG. 12 is a line chart of the illumination uniformity 1297 along the y-axis (the vertical direction) at the horizontal center of the light guides (x=0) resulting from using 25 million light rays from the LED.

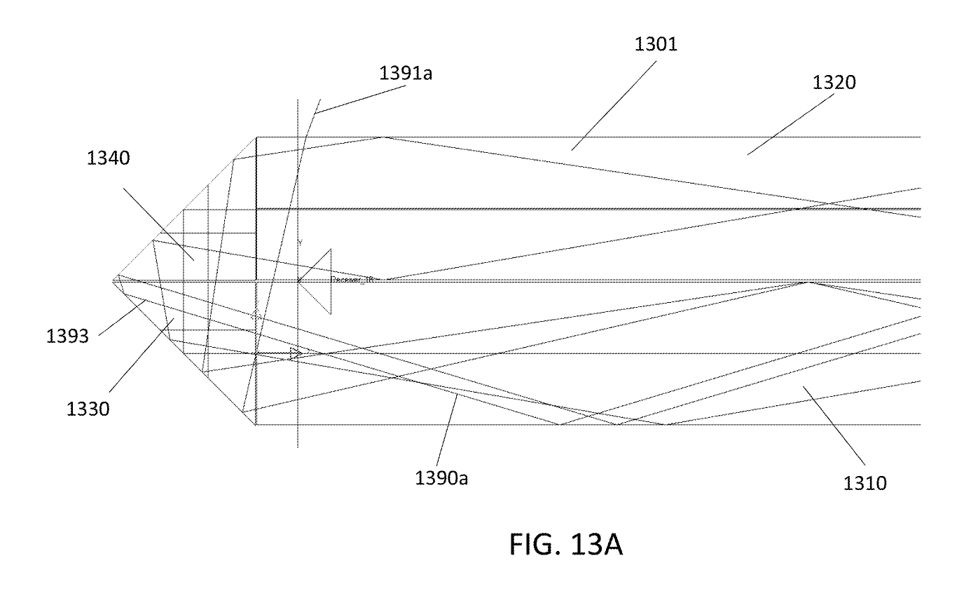

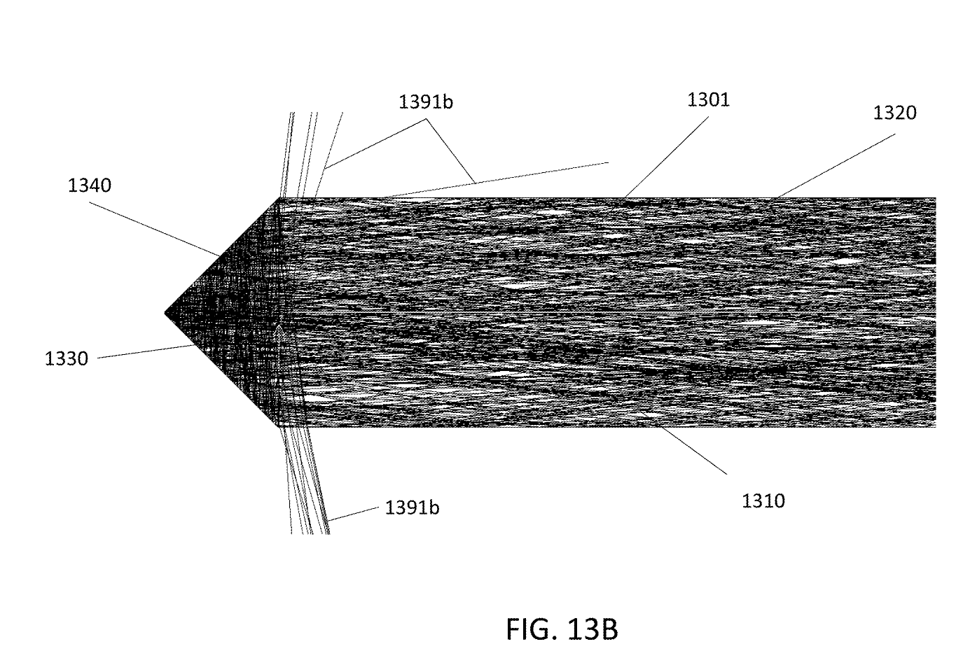

To illustrate the benefit of including low index material between the two prisms and between the prisms and the light guides, the simulation was repeated where the gaps between the first light guide, the first prism, the second prism, and the second light guide were filled with a simulated PMMA material. FIGS. 13A-13B show the resulting folded light guide article 1301 having first and second light guides 1310 and 1320 (corresponding to first and second light guides 1110 and 1120) and first and second prisms 1330 and 1340 (corresponding to first and second prisms 1130 and 1140). FIG. 13A shows the path of 4 light rays 1390a. One of the light rays 1391a does not satisfy total internal reflection (TIR) conditions and escapes from the folded light guide article 1301. Another light ray 1393 is lost from the second light guide 1320 by returning to the source. FIG. 13B shows the path of 200 light rays where it can be seen that a significant number of the light rays 1391b are lost from the second light guide by escaping TIR conditions.

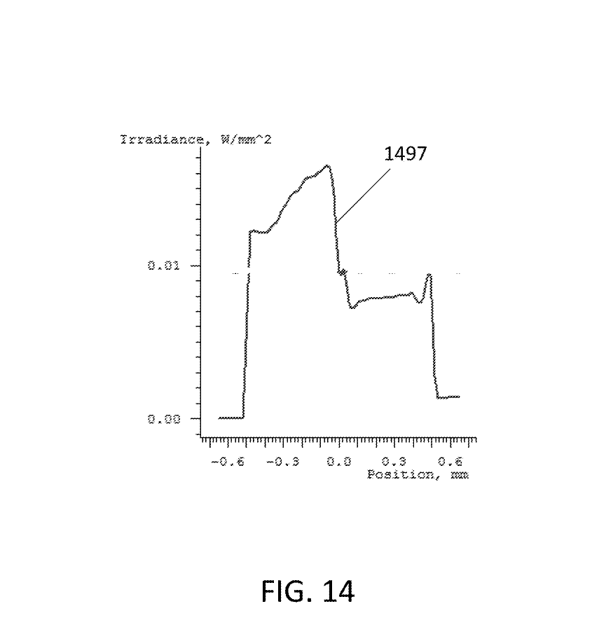

FIG. 14 is a line chart of the illumination uniformity 1497 along the y-axis (the vertical direction) at the horizontal center of the light guides (x=0) resulting from using 25 million light rays from the LED.

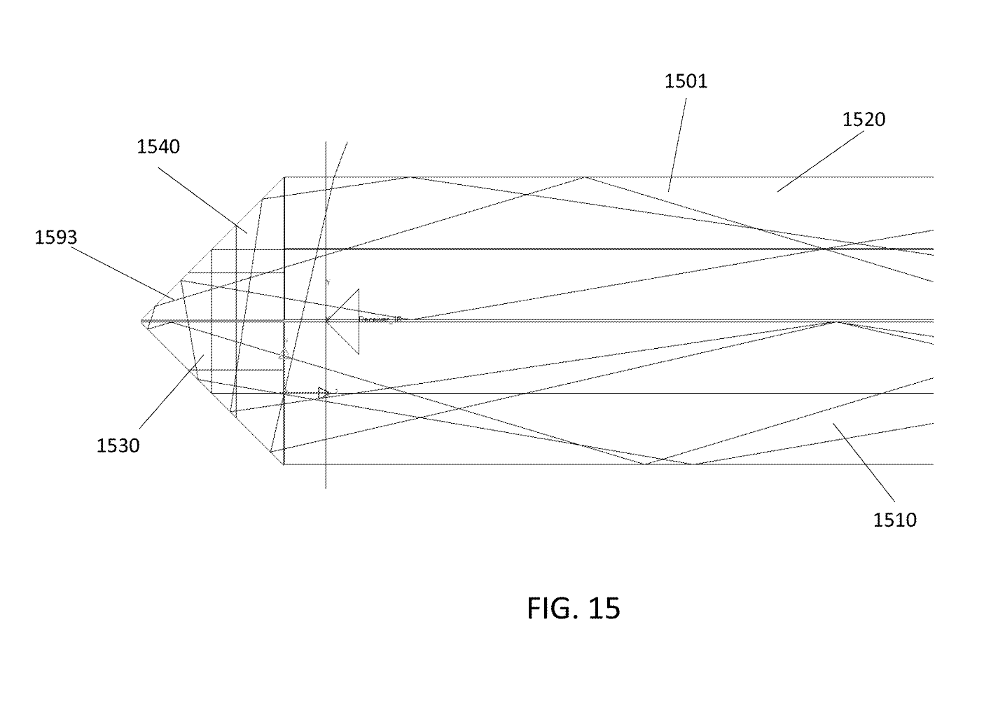

It can be seen in FIG. 13A that light ray 1393 is lost from the second light guide 1320 by returning to the source. FIG. 15 shows folded light guide article 1501 which includes first and second light guides 1510 and 1520 and first and second prisms 1530 and 1540, and which corresponds to folded light guide article 1301 except a low index material having a refractive index of 1.41 is disposed in the gap between first and second prisms 1530 and 1540. Four light rays were injected into first light guide 1510. It can be seen that the low index material prevented the loss of light ray 1593 which reflected from the low index layer, then reflected from the hypotenuse of first prism 1530, then reflected from the hypotenuse of second prism 1540 and then entered second light guide 1520. Without the low index material, light ray 1593 would have followed the path of light ray 1393 and not entered second light guide 1520.

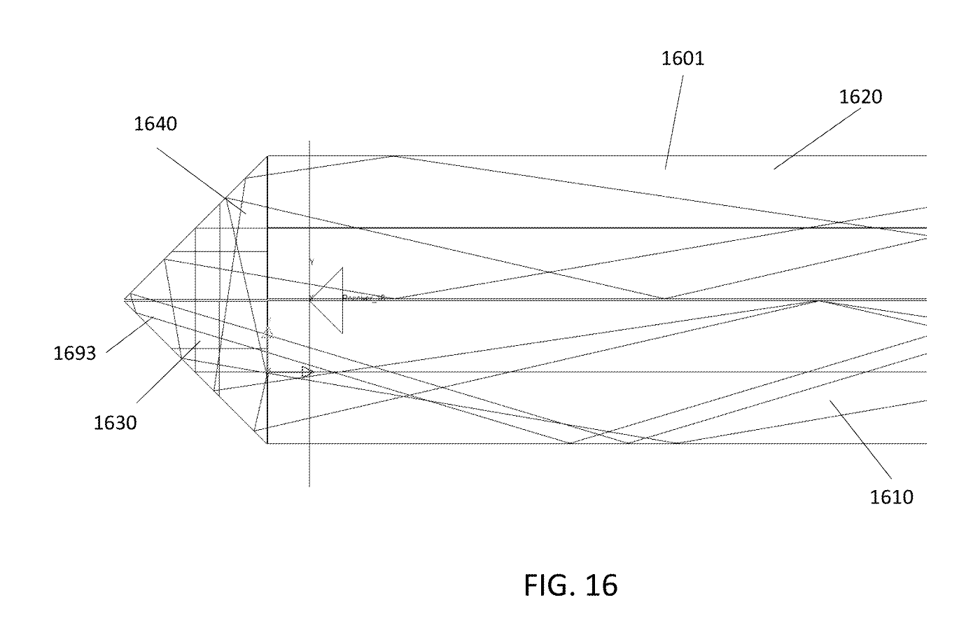

It can be seen in FIG. 13A that light ray 1391a is lost from the second light guide 1320 by escaping TIR conditions. FIG. 16 shows folded light guide article 1601 which includes first and second light guides 1610 and 1620 and first and second prisms 1630 and 1640, and which corresponds to folded light guide article 1301 except a low index material having a refractive index of 1.41 is disposed in the gap between first prism 1630 and first light guide 1610 and in the gap between second prism 1640 and second light guide 1620. Four light rays were injected into first light guide 1610. It can be seen that the low index material prevented the loss of light rays due to escaping TIR conditions. However, light ray 1693 is lost from the second light guide 1620 by returning to the source. This could be prevented, as in FIG. 15, by including a low index material between the two prisms.

Folded light guide articles 1101 and 1301 provide better uniformity than light guides which are directly lit at an edge since light output near a directly lit edge can have undesired “hot spots”. Folded light guide article 1101 provides higher throughput and better uniformity than folded light guide article 1301 because of the low index material included in the gaps in folded light guide article 1101. Comparing FIGS. 11B-11C to FIGS. 13A-13B shows that not having a lower index of refraction material in the gaps results in loss of light. Comparing FIG. 12 to FIG. 14 shows that the impact of not having a lower index of refraction in the gaps is lower efficiency and poorer uniformity. Comparing FIG. 13A to FIG. 15 shows that having a lower index of refraction material in the gaps between prisms results in a reduced loss of light and therefore an increased efficiency compared to the case where there is an index matched material between the two prisms.

The following is a list of exemplary embodiments of the present description.

Embodiment 1 is an article comprising:
a backing;
a first light guide disposed upon the backing;
a first prism disposed upon the backing adjacent the first light guide such that when the backing is folded about a first axis between the first prism and the first light guide, a first side of the first prism is positioned adjacent to and aligned with an end of the first light guide.

Embodiment 2 is the article of embodiment 1, wherein the first prism has a substantially right triangular cross-section and wherein a hypotenuse of the first prism is disposed adjacent the backing.

Embodiment 3 is the article of embodiment 1 or 2, further comprising a second prism disposed upon the backing adjacent the first prism opposite the first light guide such that when the backing is folded about a second axis between the first prism and the second prism, a first side of the second prism is positioned adjacent to and aligned with a second side of the first prism.

Embodiment 4 is the article of embodiment 3, wherein each of the first and second prisms have substantially right triangular cross-sections and wherein a hypotenuse of the first prism is disposed adjacent the backing and a hypotenuse of the second prism is disposed adjacent the backing.

Embodiment 5 is the article of embodiment 3 or 4, further comprising a second light guide disposed upon the backing adjacent the second prism opposite the first prism such that when the backing is folded about a third axis between the second prism and the second light guide, a second side of the second prism is positioned adjacent to and aligned with an end of the second light guide.

Embodiment 6 is the article of any one of embodiments 1-5, wherein the backing comprises a plurality of layers.

Embodiment 7 is the article of any one of embodiments 1-6, wherein the backing includes a low-index layer.

Embodiment 8 is the article of any one of embodiments 1-7, wherein the first prism, the first light guide and the backing comprise a common material.

Embodiment 9 is a method of making the article of any one of embodiments 1-8, comprising: providing the backing; and
forming the first light guide and the first prism on the backing.

Embodiment 10 is the method of embodiment 9, wherein the forming step comprises one or more of molding, casing and curing, and machining

Embodiment 11 is the method of embodiment 10, wherein the forming step comprises a machining step, the machining step comprising diamond point milling.

Embodiment 12 is a method of making the article of any one of embodiments 1-8, comprising: providing the backing;
forming the first light guide and the first prism;
attaching the first light guide and the first prism to the backing.

Embodiment 13 is an article comprising
a first light guide having a first end, a second end opposite the first end, a first major surface, and a second major surface opposite the first major surface;
a first prism; and
a second prism,
wherein each of the first and second prisms have a first side, a second side, a third side, and a first edge between the first side and the second side, the third side longer than the first side and longer than the second side; and
wherein the first prism is disposed with the first side of the first prism adjacent to and aligned with the first end of the first light guide, the second prism is disposed with the first side of the second prism adjacent to and aligned with the second side of the first prism with a first low-index material separating the second side of the first prism and the first side of the second prism, and the first edge of the first prism is disposed adjacent the first edge of the second prism.

Embodiment 14 is the article of embodiment 13, wherein the first and second prisms have substantially right triangular cross-sections.

Embodiment 15 is the article of embodiment 13, wherein the first and second prisms have substantially right isosceles triangular cross-sections.

Embodiment 16 is the article of any one of embodiments 13-15, wherein the first low-index material is a low-index optical adhesive.

Embodiment 17 is the article of any one of embodiments 13-15, wherein an air gap separates the second side of the first prism and the first side of the second prism and the first low-index material is air.

Embodiment 18 is the article of any one of embodiments 13-17, wherein a second low-index material separates the first end of the first light guide from the first side of the first prism.

Embodiment 19 is the article of any one of embodiments 13-18, wherein at least one of the third side of the first prism and the third side of the second prism have a reflective coating disposed thereon.

Embodiment 20 is the article of any one of embodiments 13-19, further comprising a second light guide having opposing first and second ends, the first end of the second light guide disposed adjacent to and aligned with the second side of the second prism, the second light guide having opposing first and second major surfaces, the first major surface of the second light guide disposed adjacent the second major surface of the first light guide.

Embodiment 21 is the article of embodiment 20, wherein a third low-index material separates the first end of the second light guide and the second side of the second prism.

Embodiment 22 is the article of embodiment 20 or 21, wherein a fourth low-index material separates the first major surface of the second light guide and the second major surface of the first light guide.

Embodiment 23 is the article of any one of embodiments 20-22, wherein at least one of the first major surface of the second light guide and the second major surface of the first light guide has a reflective coating disposed thereon.

Embodiment 24 is the article of any one of embodiments 20-23, further comprising:
a third light guide disposed adjacent the first major surface of the second light guide, the third light guide having first and second ends, the first end of the third light guide adjacent the second end of the second light guide;
a third prism disposed adjacent the first end of the third light guide; and
a fourth prism disposed adjacent the third prism and adjacent the second end of the second light guide.

Embodiment 25 is a backlight comprising the article of any one of embodiments 13-24.

Embodiment 26 is a display comprising the backlight of embodiment 25.

Embodiment 27 is a method of making the article of any one of embodiments 13-24 comprising:
providing an assembly including:
a backing;
the first light guide disposed upon the backing, the first major surface adjacent the backing;
the first prism disposed upon the backing adjacent to the first light guide, the third side of the first prism adjacent the backing; and
the second prism disposed upon the backing adjacent the first prism opposite the first light guide, the third side of the second prism adjacent the backing; and
folding the backing, thereby positioning the first side of the first prism adjacent to and aligned with the first end of the first light guide and positioning the second prism with the first side of the second prism adjacent to and aligned with the second side of the first prism.

Embodiment 28 is an article comprising:
a backing;
a first light guide disposed upon the backing;
a first prism disposed upon the backing adjacent to the first light guide, the first prism having first, second and third sides, the third side of the first prism longer than the first and second sides of the first prism, the third side of the first prism adjacent the backing,
wherein a length of the first side of the first prism is approximately equal to a thickness of the first light guide.

Embodiment 29 is the article of embodiment 28, wherein the first prism has a substantially right triangular cross-section.

Embodiment 30 is the article of embodiment 28 or 29, further comprising a second prism disposed upon the backing adjacent the first prism opposite the first light guide, the second prism having first, second and third sides, the third side of the second prism longer than the first and second sides of the second prism, the third side of the second prism adjacent the backing,
wherein a length of the first side of the second prism is approximately equal to a length of the second side of the first prism.

Embodiment 31 is the article of embodiment 30, wherein each of the first and second prisms have substantially right triangular cross-sections.

Embodiment 32 is the article of embodiment 30 or 31, further comprising a second light guide disposed upon the backing adjacent the second prism opposite the first prism, wherein a length of the second side of the second prism is approximately equal to a thickness of the second light guide.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. An article comprising:
a backing;
a first light guide disposed upon the backing;
a first prism disposed upon the backing adjacent the first light guide such that when the backing is folded about a first axis between the first prism and the first light guide, a first side of the first prism is positioned adjacent to and aligned with an end of the first light guide.

2. The article of claim 1, wherein the first prism has a substantially right triangular cross-section and wherein a hypotenuse of the first prism is disposed adjacent the backing.

3. The article of claim 1, further comprising a second prism disposed upon the backing adjacent the first prism opposite the first light guide such that when the backing is folded about a second axis between the first prism and the second prism, a first side of the second prism is positioned adjacent to and aligned with a second side of the first prism.

4. The article of claim 3, wherein each of the first and second prisms have substantially right triangular cross-sections and wherein a hypotenuse of the first prism is disposed adjacent the backing and a hypotenuse of the second prism is disposed adjacent the backing.

5. The article of claim 3, further comprising a second light guide disposed upon the backing adjacent the second prism opposite the first prism such that when the backing is folded about a third axis between the second prism and the second light guide, a second side of the second prism is positioned adjacent to and aligned with an end of the second light guide.

6. A method of making the article of claim 1, comprising:
providing the backing; and
forming the first light guide and the first prism on the backing.

7. A method of making the article of claim 1, comprising:
providing the backing;
forming the first light guide and the first prism;
attaching the first light guide and the first prism to the backing.

8. An article comprising
a first light guide having a first end, a second end opposite the first end, a first major surface, and a second major surface opposite the first major surface;
a first prism; and
a second prism,
wherein each of the first and second prisms have a first side, a second side, a third side, and a first edge between the first side and the second side, the third side longer than the first side and longer than the second side; and
wherein the first prism is disposed with the first side of the first prism adjacent to and aligned with the first end of the first light guide, the second prism is disposed with the first side of the second prism adjacent to and aligned with the second side of the first prism with a first low-index material separating the second side of the first prism and the first side of the second prism, and the first edge of the first prism is disposed adjacent the first edge of the second prism.

9. The article of claim 8, wherein an air gap separates the second side of the first prism and the first side of the second prism and the first low-index material is air.

10. The article of claim 8, wherein a second low-index material separates the first end of the first light guide from the first side of the first prism.

11. The article of claim 8, further comprising a second light guide having opposing first and second ends, the first end of the second light guide disposed adjacent to and aligned with the second side of the second prism, the second light guide having opposing first and second major surfaces, the first major surface of the second light guide disposed adjacent the second major surface of the first light guide.

12. The article of claim 11, further comprising:
a third light guide disposed adjacent the first major surface of the second light guide, the third light guide having first and second ends, the first end of the third light guide adjacent the second end of the second light guide;
a third prism disposed adjacent the first end of the third light guide; and
a fourth prism disposed adjacent the third prism and adjacent the second end of the second light guide.

13. A display comprising the article of claim 1.

14. An article comprising:
a backing;
a first light guide disposed upon the backing;
a first prism disposed upon the backing adjacent to the first light guide, the first prism having first, second and third sides, the third side of the first prism longer than the first and second sides of the first prism, the third side of the first prism adjacent the backing,
wherein a length of the first side of the first prism is approximately equal to a thickness of the first light guide.

15. The article of claim 14, further comprising a second prism disposed upon the backing adjacent the first prism opposite the first light guide, the second prism having first, second and third sides, the third side of the second prism longer than the first and second sides of the second prism, the third side of the second prism adjacent the backing,
wherein a length of the first side of the second prism is approximately equal to a length of the second side of the first prism.

16. The article of claim 15, wherein each of the first and second prisms have substantially right triangular cross-sections.

17. The article of claim 1, wherein the backing comprises a plurality of layers.

18. The article of claim 1, wherein the backing includes a low-index layer.

19. A display comprising the article of claim 8.

20. The article of claim 8, wherein at least one of the third side of the first prism and the third side of the second prism has a reflective coating disposed thereon.
